(19) United States
(12) Patent Application Publication
(10) Pub. No.: US 2023/0393197 A1
(43) Pub. Date: Dec. 7, 2023

(54) Systems And Methods For Debugging Cryptographic Modules

(71) Applicant: Intel Corporation, Santa Clara, CA (US)

(72) Inventor: Richard Fant, Austin, TX (US)

(73) Assignee: Intel Corporation, Santa Clara, CA (US)

(21) Appl. No.: 18/236,737

(22) Filed: Aug. 22, 2023

(51) Int. Cl. G01R 31/3177

(52) U.S. Cl. CPC G01R 31/3177

(57) ABSTRACT

An integrated circuit includes a first cryptographic module that enables debugging of the first cryptographic module and a second cryptographic module that disables debugging of the second cryptographic module. Each of the first and the second cryptographic modules has a logical cryptographic boundary that includes a first block. The logical cryptographic boundary of the first cryptographic module includes a second block that is not included within the logical cryptographic boundary of the second cryptographic module. The logical cryptographic boundary of the second cryptographic module includes a third block that is not included within the logical cryptographic boundary of the first cryptographic module.

### TECHNICAL FIELD

The present disclosure relates to electronic circuit systems and methods, and more particularly, systems and methods for debugging cryptographic modules.

### BACKGROUND

The Federal Information Processing Standards (FIPS) version 140-3 defines the requirements for a cryptographic module to be FIPS certified. A FIPS certification for a cryptographic module allows a product containing the cryptographic module to be purchased by any United States Government agency. FIPS includes different Security Levels (SL) for a cryptographic module that range from SL1 to SL4. Security Level 1 (SL1) is the lowest security level, and Security Level 4 (SL4) is the highest security level.

### BRIEF DESCRIPTION OF DRAWINGS

FIG. 1 is a flow chart that illustrates examples of operations that can be performed to power on an integrated circuit device using one of two different firmware images that implement cryptographic modules with different FIPS security levels.

FIG. 2 is a diagram that uses a dashed line to illustrate an example of the logical cryptographic boundary in an integrated circuit (IC) device for a FIPS SL2 cryptographic module.

FIG. 3 is a diagram that uses a dashed line to illustrate an example of the logical cryptographic boundary in an IC device for a FIPS SL1 cryptographic module.

FIG. 4 is a diagram of an illustrative example of a configurable integrated circuit (IC) that can include cryptographic modules as disclosed herein.

### DETAILED DESCRIPTION

Federal Information Processing Standards (FIPS) also include a Security Level 2 (SL2) for cryptographic modules. Requirement 5.16 in FIPS 140-3 (ISO 19790) states that for Security Level 2 (SL2) and higher security levels that “there shall be no services or control settings via the module interface to allow the operator to initiate or perform debugging techniques when operational.” For the purposes of FIPS, debugging techniques include starting/stopping program execution, single stepping through instructions, and reading or writing memory or registers. The lack of debugging capability for SL2 FIPS modules is an issue for all vendors that build FIPS modules.

The purpose of requirement 5.16 is to reduce the attack surface of a cryptographic module by denying an attacker a “back door” to steal information, such as Sensitive Security Parameters (SSPs). SSPs can include, for example, private keys or seed values. However, the end customer is limited in debugging any FIPS-certified cryptographic module that uses SL2 or higher security levels. In addition, the lack of debugging capability for these cryptographic modules severely hinders product development and fault-analysis for issues that occur in the field. FIPS 140-3 modules that only claim Security Level 1 (SL1) can allow debugging.

According to some examples disclosed herein, two different FIPS-certified cryptographic modules with different security levels are included in a single product. The first cryptographic module is compliant with FIPS Security Level 1 (SL1), and therefore, debugging capabilities are enabled in the first cryptographic module. The second cryptographic module is compliant with FIPS Security Level 2 (SL2), and therefore, debugging capabilities are disabled in the second cryptographic module. The first and the second cryptographic modules can be logically identical, except that debugging is disabled in the second cryptographic module. The first and the second cryptographic modules can be, for example, FIPS certified.

The first and second cryptographic modules use different firmware images in the product. The execution of the first cryptographic module (SL1) takes a different path than execution of the second cryptographic module (SL2) in response to an indication to enable debugging. This implementation complies with the FIPS requirement for not allowing debugging techniques when a cryptographic module that is compliant with SL2 or a higher security level is operational in a device. This implementation also allows a user to debug the first SL1 compliant cryptographic module, which includes the same security functions that are implemented in the second SL2 compliant cryptographic module. Thus, a user can identify sources of errors in security functions implemented by the second cryptographic module by performing debugging functions on the identical security functions that are implemented by the first cryptographic module. This implementation substantially reduces cost and effort to debug cryptographic modules.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

This disclosure discusses integrated circuit devices, including programmable (configurable) integrated circuits, such as field programmable gate arrays (FPGAs). As discussed herein, an integrated circuit (IC) can include hard logic and/or soft logic. As used herein, “hard logic” generally refers to circuits in an integrated circuit device that are not programmable by an end user. The circuits in an integrated circuit device (e.g., in a programmable IC) that are programmable by the end user are referred to as “soft logic.”

Figure (FIG.) 1 is a flow chart that illustrates examples of operations that can be performed to power on an integrated circuit device using one of two different firmware images that implement cryptographic modules with different FIPS security levels. Each of the two firmware images implements a different FIPS cryptographic module as denoted by the different certification numbers N1 and N2. The firmware image having certification number N1 implements a cryptographic module that is compliant with FIPS SL1, in which debug capabilities are enabled. The firmware image having certification number N2 implements a cryptographic module that is compliant with FIPS SL2, in which debug capabilities are disabled. The two SL1 and SL2 cryptographic modules may be, for example, FIPS certified. The integrated circuit (IC) device can be any type of IC device, such as for example, a configurable logic IC (e.g., a field programmable gate array (FPGA)), a microprocessor or central processing unit (CPU) IC, a graphics processing unit (GPU) IC, a memory IC, etc.

A user of the integrated circuit (IC) device can set a flag that is, as examples, stored in memory in the IC device or provided to the IC device during power on of the IC device. The flag indicates which of the two firmware images N1 or N2 the IC device boots into during power on. The flag can, for example, reside in the basic input output system (BIOS), non-volatile memory (e.g., flash memory), or volatile memory in the IC device. Alternatively, the user can set the value of the flag during power on of the IC device by pressing a button or by a jumper on a circuit board that the IC device is mounted on.

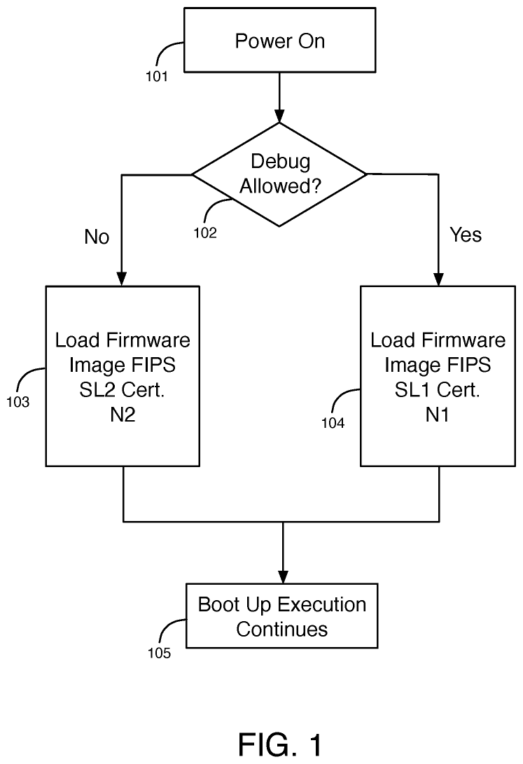

In operation 101 shown in FIG. 1, the IC device begins to power on and begins to perform operations associated with booting the IC device. In decision operation 102 during power on of the IC device, the IC device detects the value of the flag (e.g., as stored in memory or in response to user input) and determines which firmware image is to be loaded into the IC device during boot based on the value of the flag.

If the flag is set to a first value in operation 102, then the IC device loads the firmware image for the FIPS SL2 cryptographic module having certification (cert.) number N2 into the hardware in the IC device in operation 103. In some implementations, the first value of the flag is the default value of the flag, such that the IC device boots into the FIPS SL2 cryptographic module having certification number N2 by default, unless the flag is set to a second value. In these implementations, the IC device by default boots into the FIPS SL2 cryptographic module that has debugging functions disabled.

If the flag is set to the second value in operation 102, then the IC device loads the firmware image for the FIPS SL1 cryptographic module having certification number N1 into hardware in the IC device in operation 104. Thus, a user can set the flag to the second value to cause the IC device to boot (or reboot) into the FIPS SL1 cryptographic module that has debugging functions enabled in order to debug the IC device. The user can then debug the IC device using the debugging functions that are enabled in the FIPS SL1 cryptographic module. After operation 103 or 104, the IC device continues boot up execution in operation 105. The IC device can only be switched between the firmware images for the FIPS SL1 and SL2 cryptographic modules by performing operations 101-105 again. Thus, the IC device cannot switch between the firmware images for the FIPS SL1 and SL2 cryptographic modules without a hard reset or powering off and then powering on the IC device and then loading a different one of the firmware images.

The firmware images can, as an example, be implemented as configuration data bitstreams that are loaded into a configurable logic IC during power on of the IC. As another example, the firmware images can be implemented as software programs that are loaded from the BIOS into volatile memory in a processor IC during power on of the IC. Having two cryptographic modules in an IC device at different Security Levels provides substantial advantages for users by allowing users to debug the IC device using the hardware and firmware of the production version.

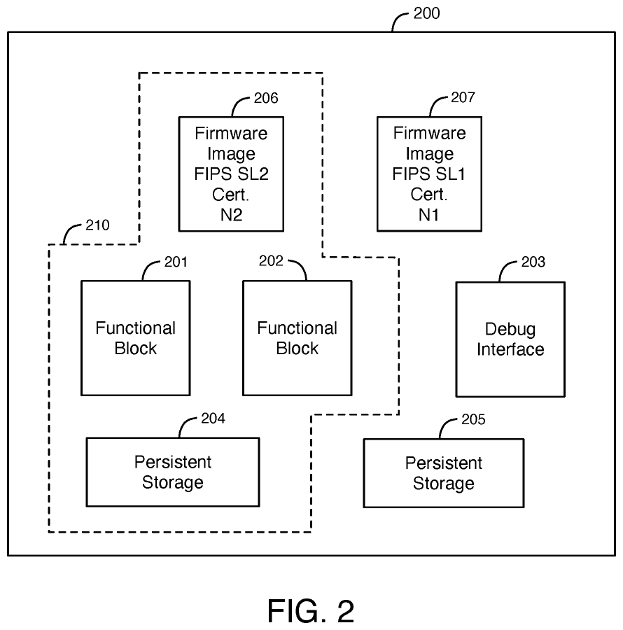

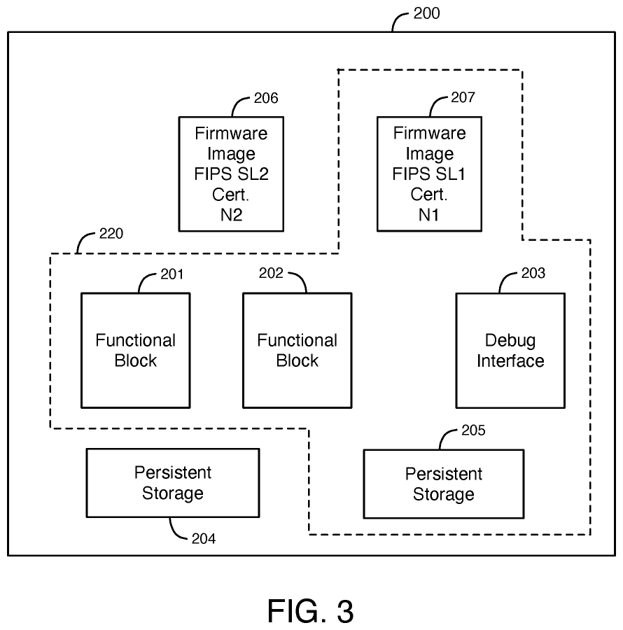

FIGS. 2 and 3 are diagrams that use dashed lines to illustrate examples of unique logical cryptographic boundaries in an electronic integrated circuit device 200 that define the cryptographic modules implemented by the two firmware images of FIG. 1. FIG. 2 is a diagram that uses a dashed line to illustrate an example of the logical cryptographic boundary 210 in IC device 200 for the FIPS SL2 cryptographic module having certification number N2 that is implemented by the firmware image 206 and loaded in IC device 200 in operation 103. The FIPS SL2 cryptographic module having certification number N2 includes the functional blocks 201 and 202 and the persistent storage block 204 that are shown within the logical cryptographic boundary 210 in FIG. 2.

FIG. 3 is a diagram that uses a dashed line to illustrate an example of the logical cryptographic boundary 220 in IC device 200 for the FIPS SL1 cryptographic module having certification number N1 that is implemented by the firmware image 207 and loaded in IC device 200 in operation 104. The FIPS SL1 cryptographic module having certification number N1 includes the functional blocks 201 and 202, a debug interface 203, and the persistent storage block 205 that are shown within the logical cryptographic boundary 220 in FIG. 3. The functional blocks 201 and 202 can be logic circuit blocks (or logic blocks). As more specific examples, functional blocks 201 and 202 can include configurable logic circuit blocks in a configurable logic IC or arithmetic logic unit (ALU) circuit blocks in a processor IC.

As shown in FIGS. 2-3, the logical boundaries 210 and 220 overlap such that the cryptographic modules implemented by the firmware images 206 and 207 in IC device 200 both include the same functional blocks 201-202. Because the SL1 and SL2 cryptographic modules implemented by the firmware images 207 and 206 include the same functional blocks 201-202, the SL1 and SL2 cryptographic modules having certification numbers N1 and N2, respectively, can perform the same logically identical functions.

However, in order to comply with FIPS 140-3, the debug interface block 203 is not included in the logical boundary 210 of the FIPS SL2 cryptographic module having certification number N2 and implemented by firmware image 206, as shown in FIG. 2. As a result, all debugging functions of the FIPS SL2 cryptographic module are disabled when the firmware image 206 is loaded in the IC device 200. The firmware image 206 can, as examples, disable the debug interface block 203 by turning off or powering down the debug interface block 203 and/or blocking all outputs and/or inputs of the debug interface block 203.

The debug interface block 203 is only included in the logical boundary 220 of the FIPS SL1 cryptographic module having certification number N1, as shown in FIG. 3. The debug interface block 203 allows a user of IC device 200 to perform debugging functions on the FIPS SL1 cryptographic module having certification number N1 when the firmware image 207 is loaded in the IC device 200. The debugging functions can include, as examples, starting/stopping program execution, single stepping through instructions, and reading or writing memory or registers. As an example that is not intended to be limiting, the debug interface block 203 can include a JTAG (Joint Test Action Group) interface and/or a JTAG controller that are used to debug the FIPS SL1 cryptographic module loaded in IC device 200.

As stated above, the SL1 and SL2 cryptographic modules implemented by the firmware images 207 and 206 can perform the same logically identical functions because the logical boundaries 220 and 210 for the SL1 and SL2 cryptographic modules both include the same functional blocks 201-202. Therefore, a user of IC device 200 can debug errors in the logical functions performed by the functional blocks 201-202 within the SL2 cryptographic module implemented by firmware image 206 by rebooting IC device 200, loading the firmware image 207 for the SL1 cryptographic module into IC device 200 as disclosed herein with respect to FIG. 1, and then debugging functional blocks 201-202 using the debugging functions provided by debug interface block 203.

In addition, the FIPS SL2 and SL1 cryptographic modules in IC device 200 include different non-overlapping persistent (e.g., non-volatile) storage blocks as shown by the logical boundaries 210 and 220 in FIGS. 2-3. The FIPS SL2 cryptographic module having certification number N2 includes persistent storage block 204, as shown within logical boundary 210 in FIG. 2. The FIPS SL1 cryptographic module having certification number N1 includes persistent storage block 205, as shown within logical boundary 220 in FIG. 3. The persistent storage blocks 204-205 can be used to store SSPs (e.g., private keys, seed values, etc.) and can be implemented by various storage devices, such as fuses, non-volatile memory circuits (e.g., flash memory), physically unclonable functions, etc. The FIPS SL1 and SL2 cryptographic modules have separate storage blocks in IC device 200, because sharing SSP values outside the logical boundary of a cryptographic module would violate FIPS requirements. When the firmware image 207 for the FIPS SL1 cryptographic module is loaded in the IC device 200, the FIPS SL1 cryptographic module cannot access persistent storage block 204 or any data stored in persistent storage block 204.

FIPS 140-3 allows a cryptographic module to exceed the requirements for any Security Level. For example, if a cryptographic module is compliant with SL2, then the cryptographic module is allowed to have some of the components of the cryptographic module implemented at Security Levels SL3 or SL4, but the overall Security Level of the cryptographic module is still SL2. Table 1 below shows examples of the security levels of a FIPS SL2 cryptographic module.

TABLE 1

| ISO/IEC 24759 Section 6 | | |
|---|---|---|
| [Number below] | FIPS 140-3 Section Title | Security Level |
| 1 | General | 2 |
| 2 | Cryptographic Module | 2 |
| | Specification | |
| 3 | Cryptographic Module | 2 |
| | Interfaces | |
| 4 | Roles, Services, and | 2 |
| | Authentication | |
| 5 | Software/Firmware Security | 2 |
| 6 | Operational Environment | 2 |
| 7 | Physical Security | 2 |
| 8 | Non-invasive Security | n/a |
| 9 | Sensitive Security Parameter | 2 |
| | Management | |
| 10 | Self-tests | 2 |
| 11 | Life Cycle Assurance | 2 |
| 12 | Mitigation of Other Attacks | n/a |

| | |
|---|---|
| Overall | 2 |

Table 2 below shows an example of a FIPS SL1 cryptographic module that has the same Security Levels as the SL2 cryptographic module of Table 1 for the security features in every row of Table 2 except for row 5. Because the SL1 cryptographic module of Table 2 allows debugging, then that portion of the cryptographic module must be at SL1, which means that the overall Security Level of the cryptographic module of Table 2 can only be at SL1.

TABLE 2

| ISO/IEC 24759 Section 6 | | |
|---|---|---|
| [Number below] | FIPS 140-3 Section Title | Security Level |
| 1 | General | 2 |
| 2 | Cryptographic Module | 2 |
| | Specification | |
| 3 | Cryptographic Module | 2 |
| | Interfaces | |
| 4 | Roles, Services, and | 2 |
| | Authentication | |
| 5 | Software/Firmware Security | 1 |
| 6 | Operational Environment | 2 |
| 7 | Physical Security | 2 |
| 8 | Non-invasive Security | n/a |
| 9 | Sensitive Security Parameter | 2 |
| | Management | |
| 10 | Self-tests | 2 |
| 11 | Life Cycle Assurance | 2 |
| 12 | Mitigation of Other Attacks | n/a |

| | |
|---|---|
| Overall | 1 |

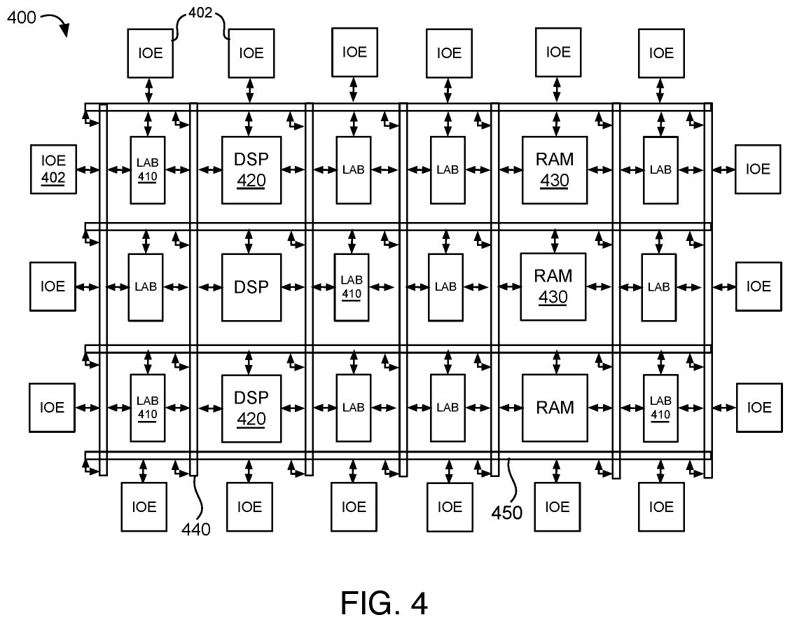

FIG. 4 is a diagram of an illustrative example of a configurable integrated circuit (IC) 400. Configurable IC 400 is an example of an IC, such as IC device 200, that can include any of the cryptographic modules disclosed herein. As shown in FIG. 4, the configurable integrated circuit 400 includes a two-dimensional array of functional blocks, including logic array blocks (LABs) 410 and other functional blocks, such as random access memory (RAM) blocks 430 and digital signal processing (DSP) blocks 420, for example. Functional blocks, such as LABs 410, may include smaller programmable regions (e.g., logic elements, configurable logic blocks, or adaptive logic modules) that receive input signals and perform custom functions on the input signals to produce output signals. LABs 410 and DSP blocks 420 are examples of the functional blocks in a cryptographic module such as functional blocks 201-202.

In addition, the configurable integrated circuit 400 may have input/output elements (IOEs) 402 for driving signals off of configurable integrated circuit 400 and for receiving signals from other devices. Input/output elements 402 may include parallel input/output circuitry, serial data transceiver circuitry, differential receiver and transmitter circuitry, or other circuitry used to connect one integrated circuit to another integrated circuit. As shown, input/output elements 402 may be located around the periphery of the IC. If desired, the configurable integrated circuit 400 may have input/output elements 402 arranged in different ways. For example, input/output elements 402 may form one or more columns of input/output elements that may be located anywhere on the configurable integrated circuit 400 (e.g., distributed evenly across the width of the configurable integrated circuit). If desired, input/output elements 402 may form one or more rows of input/output elements (e.g., distributed across the height of the configurable integrated circuit). Alternatively, input/output elements 402 may form islands of input/output elements that may be distributed over the surface of the configurable integrated circuit 400 or clustered in selected areas.

The configurable integrated circuit 400 may also include programmable interconnect circuitry in the form of vertical routing channels 440 (i.e., interconnects formed along a vertical axis of configurable integrated circuit 400) and horizontal routing channels 450 (i.e., interconnects formed along a horizontal axis of configurable integrated circuit 400), each routing channel including at least one track to route at least one wire.

Note that other routing topologies, besides the topology of the interconnect circuitry depicted in FIG. 4, may be used. For example, the routing topology may include wires that travel diagonally or that travel horizontally and vertically along different parts of their extent as well as wires that are perpendicular to the device plane in the case of three dimensional integrated circuits, and the driver of a wire may be located at a different point than one end of a wire. The routing topology may include global wires that span substantially all of configurable integrated circuit 400, fractional global wires such as wires that span part of configurable integrated circuit 400, staggered wires of a particular length, smaller local wires, or any other suitable interconnection resource arrangement.

Furthermore, it should be understood that examples disclosed herein may be implemented in any type of integrated circuit. If desired, the functional blocks of such an integrated circuit may be arranged in more levels or layers in which multiple functional blocks are interconnected to form still larger blocks. Other device arrangements may use functional blocks that are not arranged in rows and columns.

Configurable integrated circuit 400 may contain programmable memory elements. Memory elements may be loaded with configuration data (also called programming data) using input/output elements (IOEs) 402. Once loaded, the memory elements each provide a corresponding static control signal that controls the operation of an associated functional block (e.g., LABs 410, DSP 420, RAM 430, or input/output elements 402).

In a typical scenario, the outputs of the loaded memory elements are applied to the gates of field-effect transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory or programmable memory elements.

The programmable memory elements may be organized in a configuration memory array consisting of rows and columns. A data register that spans across all columns and an address register that spans across all rows may receive configuration data. The configuration data may be shifted onto the data register. When the appropriate address register is asserted, the data register writes the configuration data to the configuration memory elements of the row that was designated by the address register.

Configurable integrated circuit 400 can include configuration memory that is organized in sectors, whereby a sector may include the configuration RAM bits that specify the function and/or interconnections of the subcomponents and wires in or crossing that sector. Each sector may include separate data and address registers.

The configurable IC of FIG. 4 is merely one example of an IC that can be used with embodiments disclosed herein. The embodiments disclosed herein can be used with any suitable integrated circuit or system. For example, the embodiments disclosed herein can be used with numerous types of devices such as processor integrated circuits, central processing units, memory integrated circuits, graphics processing unit integrated circuits, application specific standard products (ASSPs), application specific integrated circuits (ASICs), and configurable logic integrated circuits. Examples of configurable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein may be stored in non-transitory computer readable storage media. Non-transitory computer readable storage media is tangible computer readable storage media that stores data for access at a later time, as opposed to media that only transmits propagating electrical signals (e.g., wires). The software code may sometimes be referred to as software, data, program instructions, instructions, or code. The non-transitory computer readable storage media may, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Additional examples are now described. Example 1 is an integrated circuit comprising: a first cryptographic module that enables debugging of the first cryptographic module, wherein the first cryptographic module comprises a first logic block; and a second cryptographic module that disables all debugging of the second cryptographic module, wherein the second cryptographic module comprises the first logic block.

In Example 2, the integrated circuit of Example 1 may optionally include, wherein the first cryptographic module further comprises a first persistent storage block in the integrated circuit, and wherein the second cryptographic module further comprises a second persistent storage block in the integrated circuit that is non-overlapping with the first persistent storage block.

In Example 3, the integrated circuit of any one of Examples 1-2 may optionally include, wherein the first cryptographic module further comprises a second logic block, and wherein the second cryptographic module further comprises the second logic block.

In Example 4, the integrated circuit of any one of Examples 1-3 may optionally include, wherein the first cryptographic module is implemented by a first firmware image, and wherein the second cryptographic module is implemented by a second firmware image.

In Example 5, the integrated circuit of any one of Examples 1-4 may optionally include, wherein the integrated circuit loads a firmware image for only one of the first cryptographic module or the second cryptographic module into the integrated circuit in response to a flag.

In Example 6, the integrated circuit of any one of Examples 1-5 may optionally include, wherein the first cryptographic module permits a user to debug the first logic block using a debug interface that is within a first logical boundary of the first cryptographic module, and wherein a second logical boundary of the second cryptographic module excludes the debug interface.

In Example 7, the integrated circuit of any one of Examples 1-6 may optionally include, wherein the first cryptographic module is compliant with Security Level 1 of Federal Information Processing Standards.

In Example 8, the integrated circuit of any one of Examples 1-7 may optionally include, wherein the second cryptographic module is compliant with Security Level 2 of Federal Information Processing Standards.

In Example 9, the integrated circuit of any one of Examples 1-8 may optionally include, wherein the integrated circuit is a configurable logic integrated circuit, and wherein the first logic block comprises configurable logic circuits.

Example 10 is a method comprising: loading in an electronic device a first firmware image of a first cryptographic module that allows debugging of the first cryptographic module in response to a flag having a first value; and loading in the electronic device a second firmware image of a second cryptographic module that prevents debugging of the second cryptographic module in response to the flag having a second value.

In Example 11, the method of Example 10 may optionally include, wherein the first cryptographic module comprises a first functional block in the electronic device, and wherein the second cryptographic module comprises the first functional block.

In Example 12, the method of Example 11 may optionally include, wherein the first cryptographic module further comprises a second functional block in the electronic device, and wherein the second cryptographic module further comprises the second functional block.

In Example 13, the method of any one of Examples 10-12 may optionally include, wherein the first cryptographic module further comprises a first persistent storage block in the electronic device, and wherein the second cryptographic module further comprises a second persistent storage block in the electronic device.

In Example 14, the method of any one of Examples 10-13 further comprises: storing first sensitive security parameters in a first non-volatile storage block in the electronic device for the first cryptographic module if the first firmware image is loaded in the electronic device; and storing second sensitive security parameters in a second non-volatile storage block in the electronic device for the second cryptographic module if the second firmware image is loaded in the electronic device.

In Example 15, the method of any one of Examples 10-14 may optionally include, wherein the second cryptographic module performs a same set of logical functions that are performed by the first cryptographic module.

In Example 16, the method of any one of Examples 10-15 may optionally include, wherein the first firmware image or the second firmware image is loaded in the electronic device only during boot of the electronic device.

Example 17 a non-transitory computer readable storage medium comprising computer readable instructions stored thereon for causing an integrated circuit to: load a first firmware image for a first cryptographic module that permits a user of the integrated circuit to debug the first cryptographic module; and load a second firmware image for a second cryptographic module that blocks the user from performing any debugging functions on the second cryptographic module, wherein a logical boundary of each of the first cryptographic module and the second cryptographic module comprises a functional block in the integrated circuit.

In Example 18, the non-transitory computer readable storage medium of Example 17 may optionally include, wherein the computer readable instructions further cause the integrated circuit to load only one of the first firmware image or the second firmware image that is selected based on a value of a flag in the integrated circuit.

In Example 19, the non-transitory computer readable storage medium of any one of Examples 17-18 may optionally include, wherein the first cryptographic module comprises first persistent memory in the integrated circuit, and wherein the second cryptographic module comprises second persistent memory in the integrated circuit that is non-overlapping with the first persistent memory.

In Example 20, the non-transitory computer readable storage medium of any one of Examples 17-19 may optionally include, wherein the first cryptographic module comprises a debug interface block.

The foregoing description of the examples has been presented for the purpose of illustration. The foregoing description is not intended to be exhaustive or to be limiting to the examples disclosed herein. In some instances, features of the examples can be employed without a corresponding use of other features as set forth. Many modifications, substitutions, and variations are possible in light of the above teachings.

1. An integrated circuit comprising:
a first cryptographic module that enables debugging of the first cryptographic module, wherein the first cryptographic module comprises a first logic block; and
a second cryptographic module that disables all debugging of the second cryptographic module, wherein the second cryptographic module comprises the first logic block.

2. The integrated circuit of claim 1, wherein the first cryptographic module further comprises a first persistent storage block in the integrated circuit, and wherein the second cryptographic module further comprises a second persistent storage block in the integrated circuit that is non-overlapping with the first persistent storage block.

3. The integrated circuit of claim 1, wherein the first cryptographic module further comprises a second logic block, and wherein the second cryptographic module further comprises the second logic block.

4. The integrated circuit of claim 1, wherein the first cryptographic module is implemented by a first firmware image, and wherein the second cryptographic module is implemented by a second firmware image.

5. The integrated circuit of claim 1, wherein the integrated circuit loads a firmware image for only one of the first cryptographic module or the second cryptographic module into the integrated circuit in response to a flag.

6. The integrated circuit of claim 1, wherein the first cryptographic module permits a user to debug the first logic block using a debug interface that is within a first logical boundary of the first cryptographic module, and wherein a second logical boundary of the second cryptographic module excludes the debug interface.

7. The integrated circuit of claim 1, wherein the first cryptographic module is compliant with Security Level 1 of Federal Information Processing Standards.

8. The integrated circuit of claim 1, wherein the second cryptographic module is compliant with Security Level 2 of Federal Information Processing Standards.

9. The integrated circuit of claim 1, wherein the integrated circuit is a configurable logic integrated circuit, and wherein the first logic block comprises configurable logic circuits.

10. A method comprising:
loading in an electronic device a first firmware image of a first cryptographic module that allows debugging of the first cryptographic module in response to a flag having a first value; and
loading in the electronic device a second firmware image of a second cryptographic module that prevents debugging of the second cryptographic module in response to the flag having a second value.

11. The method of claim 10, wherein the first cryptographic module comprises a first functional block in the electronic device, and wherein the second cryptographic module comprises the first functional block.

12. The method of claim 11, wherein the first cryptographic module further comprises a second functional block in the electronic device, and wherein the second cryptographic module further comprises the second functional block.

13. The method of claim 10, wherein the first cryptographic module further comprises a first persistent storage block in the electronic device, and wherein the second cryptographic module further comprises a second persistent storage block in the electronic device.

14. The method of claim 10 further comprising:
storing first sensitive security parameters in a first non-volatile storage block in the electronic device for the first cryptographic module if the first firmware image is loaded in the electronic device; and
storing second sensitive security parameters in a second non-volatile storage block in the electronic device for the second cryptographic module if the second firmware image is loaded in the electronic device.

15. The method of claim 10, wherein the second cryptographic module performs a same set of logical functions that are performed by the first cryptographic module.

16. The method of claim 10, wherein the first firmware image or the second firmware image is loaded in the electronic device only during boot of the electronic device.

17. A non-transitory computer readable storage medium comprising computer readable instructions stored thereon for causing an integrated circuit to:
load a first firmware image for a first cryptographic module that permits a user of the integrated circuit to debug the first cryptographic module; and
load a second firmware image for a second cryptographic module that blocks the user from performing any debugging functions on the second cryptographic module, wherein a logical boundary of each of the first cryptographic module and the second cryptographic module comprises a functional block in the integrated circuit.

18. The non-transitory computer readable storage medium of claim 17, wherein the computer readable instructions further cause the integrated circuit to load only one of the first firmware image or the second firmware image that is selected based on a value of a flag.

19. The non-transitory computer readable storage medium of claim 17, wherein the first cryptographic module comprises first persistent memory in the integrated circuit, and wherein the second cryptographic module comprises second persistent memory in the integrated circuit that is non-overlapping with the first persistent memory.

20. The non-transitory computer readable storage medium of claim 17, wherein the first cryptographic module comprises a debug interface block.
